(19) United States
(12) Patent Application Publication
(10) Pub. No.: US 2023/0404096 A1
(43) Pub. Date: Dec. 21, 2023

(54) Reduced Sugar Fruit-Flavored Dairy Product and Preparation Thereof

(71) Applicant: General Mills, Inc., Minneapolis, MN (US)

(72) Inventors: Ariel J. Buehler, Minneapolis, MN (US); Jerry L. Fultz, New Hope, MN (US); Padmini Iyer, Thane (IN); Christine S.t. Ng, Minneapolis, MN (US); Andrea Young, Minneapolis, MN (US)

(21) Appl. No.: 18/209,535

(22) Filed: Jun. 14, 2023

Related U.S. Application Data
(60) Provisional application No. 63/352,498, filed on Jun. 15, 2022.

(51) Int. Cl. A23C 9/142; A23C 9/13; A23C 9/133; B01D 61/14; B01D 61/16; B01D 61/18

(52) U.S. Cl. CPC A23C 9/1422; A23C 9/1307; A23C 9/133; B01D 61/146; B01D 61/16; B01D 61/18; B01D 2311/04; B01D 2315/16; A23C 2210/202

(57) ABSTRACT

A dairy product that is fruit-flavored and reduced in sugar includes a washed fermented dairy material and a washed fruit-based material. Separation technology for the removal of sugars from a fermented dairy material and a fruit-based material to produce the dairy product includes the repetition of a wash cycle involving a dilution step and a separation step. The separation technology achieves at least a 10% reduction in total sugars.

### CROSS REFERENCE TO RELATED APPLICATIONS

This application claims the benefit of U.S. Provisional Patent Application No. 63/352,498, filed on Jun. 15, 2022 and titled “ZERO-SUGAR AND ZERO-NET CARB DAIRY PRODUCT AND PREPARATION THEREOF”. The entire content of this application is incorporated by reference.

### FIELD OF THE INVENTION

The invention generally pertains to cultured dairy products (animal-derived or non-animal-derived) and methods of making cultured dairy products. More particularly, the invention is related to cultured dairy products, such as yogurt (animal-derived or non-animal-derived), that have reduced sugar but are flavored with real fruit, as well as technology for preparing such cultured dairy products.

### BACKGROUND OF THE INVENTION

Many consumers enjoy yogurt and other similar dairy products but there is growing demand for such products to have a reduced sugar content and/or a low total or net carbohydrate content. Traditionally, yogurt and other similar dairy products are made by a process that includes a step of fermenting a dairy material with, e.g., lactic acid bacteria. However, a significant amount of carbohydrates (e.g., unfermented sugars) typically remain in the fermented dairy product. A significant amount of sugar can also arise from fruit-based materials mixed with the yogurt or other similar dairy products to provide desired flavors. Some manufacturers have attempted to reduce the sugar content of fermented dairy products in different ways, such as by first filtering the starting dairy material to reduce the sugar content before the fermentation step or by adding additional bacterial cultures or enzymes to achieve higher/complete conversion of the sugars during the fermentation step. However, such processes typically require longer fermentation, and the resulting product still includes a level of carbohydrates that is reported on its nutrition label and impacts the caloric and net carbohydrate content of the product. Such processes also do not address the sugar content of any fruit-based materials to be included.

### SUMMARY OF THE INVENTION

The present invention is directed to a reduced sugar fruit-flavored dairy product. The present invention is further directed to separation technology for removal of sugars from fruit-flavored fermented dairy material to produce a fruit-flavored dairy product having reduced sugar.

A process in accordance with the present invention includes providing a fermented dairy material having sugars. Preferably, the fermented dairy material provided is a yogurt. The provided fermented dairy material is subjected to a first dilution step with a dilution liquid and then a separation step. In the first dilution step, a fruit-based material is added to the fermented dairy material, either directly or as part of a first dilution liquid. In the separation step, liquid including diffused sugars (e.g., unfermented lactose, galactose, etc.) and organic acids from the dairy material and fruit-based material is separated by one or more separation methods. Examples of the one or more separation methods include but are not limited to membrane filtration (e.g., using a cross-linked membrane, separation is based on molecular weight, chain length, or other properties of the solutes), centrifugation, regular filtration, ion exchange or chromatography separation. A washed fermented dairy material and a filtrate are formed.

The wash cycle, i.e., the combined steps of diluting and separating, is repeated at least once more, where the washed fermented dairy material is subjected to further dilution and separation. In certain preferred embodiments, fruit-based material is only added in the first dilution step. The wash cycle is repeated until the desired levels of sugars and organic acids are achieved in the washed fermented dairy material. The number of times the wash cycle is repeated is primarily dependent upon the levels of sugars and organics acids in the provided fermented dairy material and fruit-based material and the levels of sugars and organic acids desired and/or required in the final product. The number of times the wash cycle is repeated also depends upon the equipment employed. In some embodiments, the wash cycle is performed at least four times (e.g., six times).

A system in accordance with the present invention includes multiple separation stages (i.e., at least two separation stages). In some embodiments, the system includes at least four stages (e.g., six stages). In each stage, a fermented dairy material (initial fermented dairy material in the first stage and washed fermented dairy material in subsequent stages) is introduced via an inlet and subjected to dilution with a dilution liquid (also introduced via an inlet) and then separated via one or more separation technologies. In the first stage, fruit-based material is introduced directly to the fermented dairy material or as part of the dilution liquid. Examples of the one or more separation technologies include but are not limited to membrane filtration (e.g., using a cross-linked membrane, separation is based on molecular weight, chain length, or other properties of the solutes), centrifugation, regular filtration, ion exchange or chromatography separation. In some embodiments, one or more of spiral wound, plate and frame, or ceramic tubular membrane filtration (e.g., ultrafiltration (UF) membranes) is employed in each stage.

A washed fermented dairy material and a filtrate are generated in each stage, exiting at respective outlets. When applicable (e.g., if the dairy material has been washed less than four times), the washed fermented dairy material is then introduced to an inlet of the next stage for further processing while the filtrate is removed, potentially for other uses.

The process and system of the present invention achieve at least a 10% reduction (e.g., from about 10% to about 0% reduction) in total sugars, at least an 30% reduction in organic acids (e.g., 82%) and at least a 10% reduction in total carbohydrates (e.g., at least 90%).

A dairy product in accordance with the present invention is fruit-flavored and reduced in sugar. Preferably, the dairy product is a yogurt or a cream cheese. The dairy product includes a washed fermented dairy material including reduced sugar fruit-based material and having an organic acid content of 1.0 wt % or less and a protein to carbohydrate ratio of at least 1.1:1.

### BRIEF DESCRIPTION OF THE DRAWINGS

FIG. 1 is a diagram illustrating a process in accordance with the present invention.

FIG. 2 is a diagram illustrating a system in accordance with the present invention.

### DETAILED DESCRIPTION

Initially, it should be noted that the embodiments of the present invention described below are not intended to be exhaustive or limit the invention to the precise forms disclosed in the following detailed description. Rather, a purpose of the embodiments chosen and described is so that the appreciation and understanding by others skilled in the art of the principles and practices of the present invention can be facilitated. Also, it should be realized that the embodiments described in the below paragraphs for the inventive process, system and/or product are not mutually exclusive and therefore can be combined in connection with other embodiments.

Throughout the present description, unless otherwise specified, the concentrations expressed as percentages always refer to the weight/weight (w/w) percentage, i.e., grams of a given component per 100 g of composition, i.e., wt % or percent by weight. The term “about” refers to a deviation of up to plus/minus 10%, preferably plus/minus 5%.

The term “dairy” refers to materials, compositions or products, based on or derived from, at least partially, animal milk (e.g., cow milk, sheep milk, goat milk, water buffalo milk, or bison milk, preferably cow milk) or non-animal milk ingredients (e.g., plant-based materials). Non-animal milk ingredients can include ingredients produced by precision fermentation which involves programming simple microorganisms (e.g., using recombinant DNA technology or biomass or cellular fermentation) to produce specific, desired organic molecules (e.g., proteins such as casein). The terms “fermented dairy” or “cultured dairy” are used herein to describe acidic or fermented dairy issued from a step of acidification of a liquid material (“starting dairy material”), at least a portion of which is a dairy liquid material. Acidification can be performed by fermentation. Lactic acid bacteria are typically used for the fermentation process. Lactic acid bacteria convert lactose in a starting dairy material (e.g., milk) to lactic acid and galactose (and/or other simple sugars). In turn, the pH is lowered which causes protein in the dairy material to precipitate and form a curd. The curd is a protein matrix in which a liquid whey component is entrapped. Fermented dairy can be strained or unstrained (e.g., using ultrafiltration or centrifugal separation) and can further include a prep (see definition for “prep” below). “Strained fermented dairy” has a thicker consistency relative to unstrained fermented dairy because most of the whey is removed from the curd as a consequence of a separation step. “Washed fermented dairy” refers to fermented dairy which has been treated with a dilution liquid and subsequently has some, most or all of its whey or other generated liquid (e.g., wash water) separated therefrom. “Dilution liquid” is an aqueous liquid in which water-soluble small molecules (e.g., sugars and organic acids) that are found in a material to be diluted (e.g., fermented dairy) can be diffused. The aqueous liquid with the diffused solutes therein (aqueous solution) can be separated as a filtrate. The term “filtrate” refers to the portion (or entirety) of this aqueous solution that is separated and is not limiting in regard to the particular separation technology employed in the separation (e.g., not limited to regular filtration). For example, the term “filtrate” can encompass “permeate” (e.g., from membrane filtration) or “supernatant” (e.g., from centrifugation) or other analogous terms known to those in the art. “White mass” or “white base” are terms used to refer to the material, primarily containing the curd/protein matrix, that remains after most (e.g., over 75%) or all of the whey component/filtrate/wash water is separated from a fermented dairy material/diluted dairy material. White mass typically includes casein in the form of a thick gel and is so-called because it is typically white in color. Non-limiting examples of forms of fermented dairy products (animal-derived or non-animal derived) include, for example, products in the form of yogurt, Greek yogurt (strained), fresh cheeses, strained yogurt drinks and frozen strained yogurt products.

In the present invention, the dilution liquid can include “fruit-based material” which refers to a derivative of a whole edible fruit (e.g., blueberry, strawberry, cherry, banana) that is liquid (e.g., juice) or semi-solid (e.g., puree). In some embodiments, the fruit-based material can be applied separately from the dilution liquid. The incorporation of fruit-based material with a fermented dairy material per the present invention yields a “fruit-flavored” dairy product or a “dairy product with real fruit”.

The term “diafiltration” refers to a dilution process in which the concentration of solutes (e.g., sugars, organic acids) is reduced in an aqueous phase such that when a subsequent separation occurs (e.g., using tangential flow filtration), a more dilute aqueous phase is removed (“permeate”; water and permeable components) and the remaining aqueous phase in the washed retentate (“concentrate”; retained water and non-permeable components) has a reduced concentration of the solutes. In contrast, a regular membrane separation process aims at concentration of ingredients, with partial removal of solutes happening as a by-product of the process.

The term “sugar” or “sugars” refers to one or more particular carbohydrates that are naturally found in dairy material or fruit-based material, e.g., lactose, galactose, glucose, galacto-oligosaccharides, or mixtures thereof “Added sugar” refers to non-naturally occurring sweet-tasting carbohydrates that are added to a product during processing/manufacturing. The terms “zero-sugar” or “substantially free of sugars” as used herein refer to the combined amounts of sugar and added sugar (i.e., “total sugars”) in a material or product being undetectable or less than 0.29% by weight (e.g., less 0.17% by weight or 0.128% by weight). The term “reduced sugar” as used herein refers to a reduction in total sugar ranging from about 10% to about 60% (e.g., at least 20%). “Reduced sugar fruit-based material” or “washed fruit-based material” refers to fruit-based material which has been treated with a dilution liquid and subsequently has some, most or all of its sugars separated therefrom.

The term “organic acid” or “organic acids” refers to one or more particular acidic organic compounds that occur in dairy material or fruit material naturally or are produced during fermentation of dairy material, such as, but not limited to acetic acid, citric acid, fumaric acid, gluconic acid, malic acid, lactic acid, oxalic acid, propionic acid, quinic acid, succinic acid, tartaric acid, butyric acid, or mixtures thereof. The term “substantially free of organic acids” as used herein refers to the amounts of organic materials in a material or product being undetectable or less than 0.7% by weight (e.g., no more than 0.2% by weight or 0.101% by weight).

The term “carbohydrates” refers to components other than crude protein, fat, moisture, or minerals that can be found in dairy material or products. Carbohydrates include, e.g., sugar, added sugar and organic acid as defined herein as well as dietary fiber and sugar alcohols. The terms “total carbohydrates” or “total carbohydrate content” refer to the amount of carbohydrates in a product serving (e.g., in grams). The terms “net carbs” or “net carbohydrates” or “net carbohydrate content” are used herein to refer to the amount of carbohydrates in a product serving that are digestible. Typically, net carbs are calculated by subtracting the amounts of, e.g., dietary fiber and sugar alcohol (e.g., erythritol) in a serving of a product (e.g., in grams) from the total carbohydrates in the serving, as dietary fiber and sugar alcohols are largely indigestible. If present, sucralose (a sweetener) is another ingredient that is subtracted from the total carbohydrates when calculating net carbs. The terms “zero-net carb” or “zero net carbs” refers to the net carbohydrate content of a material or product being less than 0.5 grams per serving.

The term “protein to carbohydrate ratio” refers to a ratio by weight of protein to carbohydrate, i.e., grams of a protein per gram of carbohydrate in a certain material, composition or product.

As used herein, “prep” or “blank prep” refers to a preparation used to modify the taste, mouthfeel and/or texture of a dairy material, e.g., a fermented dairy material. A prep can include ingredients such as sweetening agents (e.g., sugar alcohols, allulose or sucralose), flavoring agents, coloring agents and stabilizers (e.g., guar gum). In some embodiments, a prep includes a fruit juice and/or a fruit puree. A prep typically does not contain dairy materials itself and is typically added to the dairy material as part of a last step in preparing a dairy-based product.

There is an ever-growing demand from consumers that want to generally reduce sugar and/or carbohydrates in their diet without compromising on taste and texture. There is a wide range of dairy products (e.g., yogurts) in the “weight management,” “healthy living” or “free from sugar” product range that do not contain any added sugars. But these products, especially these products having real fruit included, still contain some naturally occurring sugars such as lactose. In the case of fermented dairy products, even though lactose gets converted to lactic acid during fermentation, there is still unfermented lactose (and/or galactose) that remains in the product. Unfermented sugars as well as organic acids that are produced during fermentation (e.g., lactic acid) and remain in the product are accounted for on the product's nutrition label, in particular contributing to the “total carbohydrates” component, the “net carbs” component (if displayed), and the “sugars” component. Any fruit-based material mixed with the fermented dairy product typically also contains sugar that contributes to the total carbohydrates.

The present invention is directed to a reduced sugar fruit-flavored dairy product. The present invention is further directed to separation technology for removal of sugars from fermented dairy material mixed with fruit-based material to produce a reduced sugar fruit-flavored dairy product.

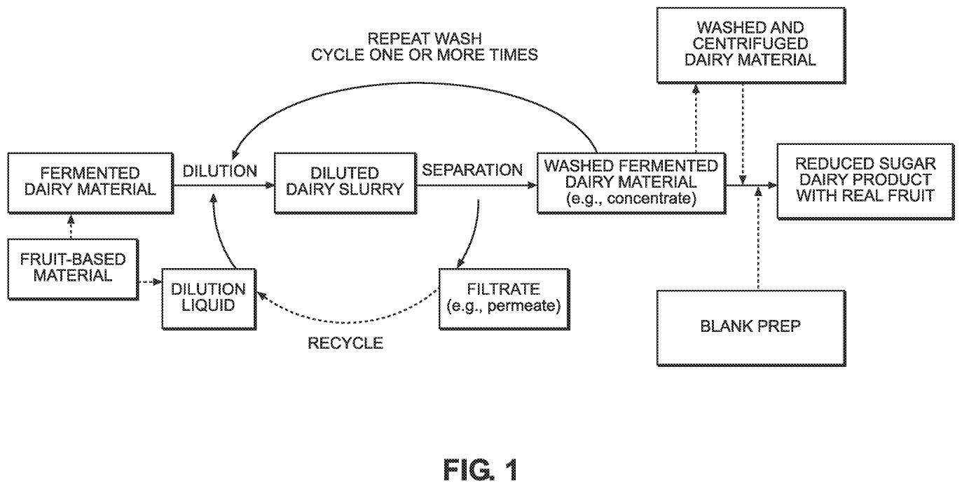

FIG. 1 illustrates a process in accordance with the present invention. Initially, a fermented dairy material is provided. In some embodiments, the fermented dairy material provided is a yogurt. For example, a Greek yogurt or yogurt made from ultrafiltered milk. In some embodiments, the fermented dairy material provided is suitable for forming a cream cheese product. However, other fermented dairy materials can be provided.

A fruit-based material is added to the fermented dairy material, either directly or as part of a first dilution liquid. The fruit-based material has a volume and, in some embodiments, the volume of the fruit-based material is 5-50% (preferably, 10-30%) of the volume of the provided fermented dairy material.

Next, the fermented dairy material is subjected to a dilution step. A first dilution liquid is provided (including or separate from the fruit-based material) and mixed with the fermented dairy material (e.g., by whisking) to form a first diluted dairy slurry. In some embodiments, the first dilution liquid consists essentially of water. In some embodiments, the volume of the first dilution liquid provided is 15-50% (e.g., 15-30%) of the volume of the initially provided fermented dairy material. In some embodiments, the volume of the first dilution liquid provided is up to 150% (e.g., 125%) of the volume of the initially provided fermented dairy material. In some embodiments, the volume of dilution liquid provided is up to 300% of the volume of the initially provided fermented dairy material. Adding the dilution liquid to the fermented dairy material allows small water-soluble molecules such as sugars (e.g., unfermented lactose, galactose), organic acids and minerals present in the liquid whey of the fermented dairy material and fruit-based material to diffuse into the dilution liquid.

The first diluted dairy slurry is then subjected to a separation step to form a washed fermented dairy material (e.g., a concentrate) and a filtrate (e.g., a permeate). In this separation step, the dilution liquid including diffused sugars (e.g., unfermented lactose, galactose) and organic acids therein is separated from the combined fruit-based material and white base of the diluted dairy slurry by one or more separation methods. Examples of the one or more separation methods include but are not limited to membrane filtration (e.g., using a cross-linked membrane, separation is based on molecular weight, chain length, or other properties of the solutes), centrifugation, regular filtration, ion exchange or chromatography separation. The separated white base/fruit-based material is considered a washed fermented dairy material, as it has gone through the above dilution and separation steps. As shown by a dotted arrow line in FIG. 1, the filtrate may optionally be recycled and used in further dilution steps as part of (or entirely) the dilution liquid.

The wash cycle, i.e., the combined steps of diluting and separating, is repeated at least one more time (e.g., iterative dilution; batch operation), where the washed fermented dairy material is subjected to further dilution (e.g., with a second dilution liquid) and separation to achieve the desired sugar/organic acid removal. In preferred embodiments, fruit-based material is only added in the first dilution step. In some embodiments, the wash cycle achieves a washed fermented dairy material having increased viscosity. The number of times the wash cycle is repeated depends upon the choice of equipment as well as the amount of sugar/organic acid in the starting provided fermented dairy material and fruit-based material and the desired levels of sugar/organic acid in the product. In some embodiments, the wash cycle is performed at least four times (e.g., six times, or up to 13 times). In some embodiments, the wash cycles are performed continuously. With each cycle, both the filtrate and the washed fermented dairy material contain fewer amounts of sugars and organic acids. The wash cycle is ideally repeated until desired levels of sugars/organic acids are achieved in the washed fermented dairy material. As such, the number of wash cycles typically depends on the amount of sugar and organic acid in the starting provided fermented dairy material, the solubility of the sugars and organic acids (i.e., solutes) in the dilution liquid, and/or the equipment design (e.g., throughput and residence time and, if membrane filtration is employed, the pore size of the membrane and the interactions between the membrane and the solutes). In some embodiments, the wash cycle is repeated until the washed fermented material has from about 10% to about 40% less sugar. In some embodiments, the wash cycle is repeated until the washed fermented material has less than 2.5% total carbohydrates (e.g., 1.6% or less, 0.4% or less), less than 0.5% total sugars (e.g., between 0.100% and 0.350%), less than 0.7% organic acids, at least 11% protein, and/or a protein to carbohydrate ratio of at least 1.1:1 (e.g., at least 33:1). When a cream cheese product is being made, the method of making the cream cheese product in accordance with a method of the present invention is less time consuming than the traditional or conventional method of making cream cheese.

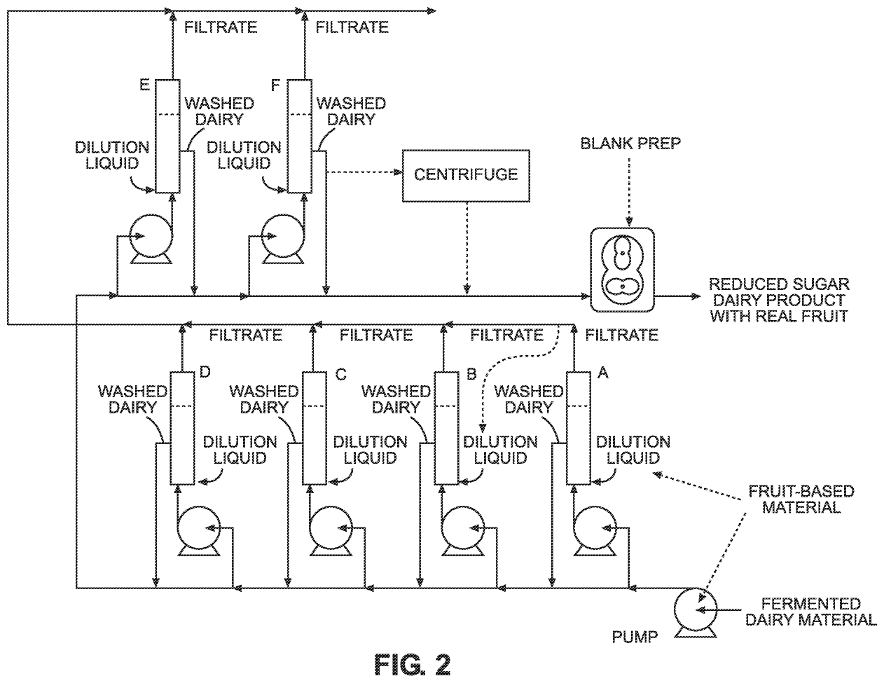

In some embodiments, the repeating of the wash cycle is achieved using multiple separation stages as described with reference to FIG. 2. FIG. 2 illustrates a system in accordance with the present invention for preparing a reduced sugar fruit-flavored dairy product (or “reduced sugar dairy product with real fruit”). Each separation stage A-F represents one wash cycle. As shown in FIG. 2, six stages are employed. However, as little as two stages or as many as ten stages could be employed in accordance with the present invention.

In each stage, a fermented dairy material (initial fermented dairy material in stage A and washed fermented dairy material in subsequent stages B-F) is introduced via an inlet and, e.g., a pump and subjected to dilution with a dilution liquid (also introduced via an inlet) and then separated via one or more separation technologies. In the first stage, a fruit-based material is introduced via an inlet either directly to the initial fermented dairy material or to the first dilution liquid. Examples of the one or more separation technologies include but are not limited to membrane filtration (e.g., using a cross-linked membrane, separation is based on molecular weight, chain length, or other properties of the solutes), centrifugation, regular filtration, ion exchange or chromatography separation. In some embodiments, one or more of spiral wound, plate and frame, or ceramic tubular membrane filtration (e.g., ultrafiltration (UF) membranes) is employed in each stage. A spiral wound UF membrane includes flexible membranes wound around a filtrate collection tube, with a pair of the membranes being separated by a permeate spacer mesh or grid to allow for fluid flow. In some embodiments, one or more of the separation stages is configured to perform diafiltration. The fermented dairy inlet, the fruit-based material inlet and the dilution liquid inlet may be distinct or shared inlets. When membrane separation technology is used, pressure from a fermented dairy material introduction pump can be used to cause filtrate to separate from the fermented dairy material through the one or more membranes. In the case of a spiral wound membrane, the pressure causes the filtrate to enter the collection tube. In some embodiments, the one or more membranes employed in the system of the present invention have semi-permeable walls, featuring pores which allow substances of molecular weight up to 25,000 Da to exit. Preferably, the membrane specifications are selected based upon the viscosity of the material being separated in order to prevent unnecessary protein loss. In some embodiments, as the washed fermented dairy material increases in viscosity with each wash cycle/stage, larger spacers are used for the spiral wound UF membranes. In some embodiments, the introduction pump at each subsequent stage applies more pressure compared to the pump used in the previous stage.

A washed fermented dairy material and a filtrate are generated in each stage, exiting at respective outlets. When applicable (e.g., if the dairy material has been washed less than four times), the washed fermented dairy material is then introduced to an inlet of the next stage for further processing while the filtrate is removed, potentially for other uses. Optionally, the filtrate is processed (e.g., to remove solutes) and recycled to be used in or as the subsequent stage's dilution liquid. See the dashed line between stages A and B. In some embodiments, the volume of dilution liquid added at the beginning of a wash cycle equals the volume of filtrate removed from the previous cycle. In some embodiments, the volume of dilution liquid added at the beginning of a wash cycle is less than the volume of filtrate removed from the previous cycle to allow for simultaneous washing and concentration of the washed fermented dairy material. In some embodiments, the combined dilutions (total over all the stages) may be up to 300% of the volume of the initially provided fermented dairy material.

As shown in both FIGS. 1 and 2, the washed fermented dairy material, after the completion of the wash cycles, can be optionally subjected to centrifugation to yield a washed and centrifuged dairy material.

In some embodiments, after the completion of the wash cycles and optional centrifugation, the treated dairy material (including reduced sugar fruit-based material) may be combined with a prep to create a reduced sugar fruit-flavored dairy product having a desired consistency, calorie content and/or texture. The term “prep” is defined above. In some embodiments, 65-100% (e.g., 65-75% or 65%-90%) of the reduced sugar dairy product is the washed fermented dairy material (including washed fruit-based material) and 0-35% (e.g., 25-35% or 10-35%) of the dairy product is the prep. The prep in accordance with the present invention does not include added sugars or organic acids such that the resulting dairy product does not have net carbs. In some embodiments, the prep includes allulose and/or sucralose as sweetening agents.

A reduced sugar fruit-flavored dairy product in accordance with the present invention is preferably a yogurt or a cream cheese. The dairy product includes a washed fermented dairy material component including reduced sugar fruit-based material and having an organic acid content of 1.0 wt % or less. In some embodiments, the washed fermented dairy material component of the dairy product has less than 2.5% total carbohydrates (e.g., 1.6% or less, 0.4% or less), less than 0.5% total sugars (e.g., between 0.100% and 0.350%), less than 0.7% organic acids, at least 11% protein, and/or a protein to carbohydrate ratio of at least 1.1:1 (e.g., at least 33:1). In some embodiments, the dairy product further includes a prep. The dairy product can include 0-35 wt % prep (e.g., 25-35%) and 65-100 wt % (e.g., 65-75%) washed fermented dairy material having an organic acid content of 1.0 wt %.

As previously mentioned, it should be realized that the embodiments described in the above paragraphs for the inventive process, system and/or product are not mutually exclusive and therefore can be combined in connection with other embodiments.

### EXAMPLES

### Example 1—Diafiltration of Fermented Yogurt Base Mixed with Fruit Juice

1) A fermented yogurt base is provided, and cherry fruit juice is added thereto in an amount 25% the volume of the fermented yogurt base to yield a base with added juice having a first volume and a first weight (“Base with 25% juice addition” in Table 1 below).
2) 1 liter of diafiltration water is added to the base with added juice and the resulting mixture is diafiltered to yield a first concentrate (“Concentrate 1”) having a volume the same as the original first volume, and a first permeate.
3) Step 2 is repeated until the total diafiltration water employed is around 95.2% of the first weight (weight of the original base with added juice).

Table 1 shows compositional and pH details at various stages of the process. The pH was kept close to 4.6 for food safety assurances and/or to prevent protein agglomeration.

TABLE 1

| | Total | Total | |
|---|---|---|---|
| | Sugars | Protein | |
| | (%) | (%) | pH |
| Base with 25% | 6.75 | 2.75 | 4.18 |
| juice addition | | | |
| Concentrate 1 | 7.29 | 4.24 | 4.19 |
| (after 1 liter of | | | |
| diafiltration water) | | | |
| Concentrate 2 | 5.12 | 4.59 | 4.28 |
| (after 6 liters of | | | |
| diafiltration water) | | | |
| Concentrate 3 | 3.87 | 3.95 | 4.39 |
| (after 10 liters of | | | |
| diafiltration water) | | | |
| Final Concentrate | 5.31 | 7.94 | 4.45 |

The diafiltration achieved a 21.3% reduction in total sugars while maintaining color (Table 2) and flavor (Table 3). Color (Table 2) is measured using the Hunter L*a*b color scale, wherein “L*” corresponds to a lightness measurement based on a black to white scale, “a*” corresponds to measurements on a red to green scale and “b*” corresponds to measurements on a blue to yellow scale.

TABLE 2

| | L* | a* | b* |
|---|---|---|---|
| Base with 25% | 66.33 | 12.75 | 4.14 |
| juice addition | | | |
| Final | 72.03 | 13.04 | 3.08 |
| Concentrate | | | |
| Final Permeate | 2.46 | 12.72 | 4.24 |

TABLE 3

| | Cherry | Base/Juice | Final | Final |
|---|---|---|---|---|
| | Juice | Blend | Permeate | Concentrate |
| Compound | ppm | ppm | ppm | ppm |
| Acetaldehyde | 0.09 | 0.19 | 0.07 | 0.12 |
| Ethanol | 11.32 | 8.64 | 2.64 | 2.52 |
| Isopropyl | 0.61 | 1.75 | 1.66 | 1.67 |
| alcohol | | | | |
| Acetone | 13.71 | 5.19 | 1.75 | 3.78 |
| 2,3- | 0.23 | 0.95 | 0.35 | 0.89 |
| butanedione | | | | |
| 2-butanone | nd | 0.10 | 0.08 | 0.16 |
| 3-penten-2-ol | 0.81 | 0.22 | 0.04 | 0.06 |
| Acetic acid | 0.83 | 0.73 | 0.18 | 0.06 |
| 3-methyl- | 0.16 | 0.04 | nd | nd |
| butanal | | | | |
| 2,3- | nd | 0.08 | 0.03 | 0.03 |
| pentanedione | | | | |
| Acetoin | nd | 3.94 | 0.73 | 0.73 |

Table 4 shows a retention of certain organic acid components as well.

TABLE 4

| | Citric | Gluconic | Lactic | Malic | Quinic |
|---|---|---|---|---|---|
| | Acid | Acid | Acid | Acid | Acid |
| | (%) | (%) | (%) | (%) | (%) |
| Base with 25% | 0.105 | 0.235 | 0.745 | 0.250 | 0.186 |
| juice addition | | | | | |
| Final | 0.103 | 0.150 | 0.386 | 0.143 | 0.137 |
| Concentrate | | | | | |
| Final | 0.026 | 0.113 | 0.282 | 0.085 | 0.065 |
| Permeate | | | | | |

Although described with reference to particular embodiments of the invention, it should be understood that various changes and/or modifications can be made to the invention without departing therefrom as encompassed by the following claims.

1. A method of making a reduced sugar fruit-flavored dairy product, the method comprising:
a) providing a fermented dairy material having sugars;
b) adding a volume of a first dilution liquid including a fruit-based material to the fermented dairy material to form a first diluted dairy slurry; and
c) separating the first diluted dairy slurry into a first washed fermented dairy material and a first filtrate.

2. The method of claim 1, wherein the fermented dairy material is an animal-derived yogurt or a non-animal-derived yogurt.

3. The method of claim 1, wherein the fruit-based material is a fruit juice or a fruit puree.

4. The method of claim 1, wherein the volume of the first dilution liquid is 5-50% of the volume of the fermented dairy material provided in step a).

5. The method of claim 1, further comprising
d) adding a volume of a second dilution liquid to the first washed fermented dairy material to form a second diluted dairy slurry; and
e) separating the second diluted dairy slurry into a second washed fermented dairy material and a second filtrate.

6. The method of claim 1, wherein at least part of the first filtrate is recycled into part or all of the volume of the second dilution liquid.

7. The method of claim 1, wherein step c) is performed by centrifugation.

8. The method of claim 1, wherein step c) is performed using one or more filtration membranes.

9. The method of claim 5, further comprising:
f) adding a volume of a third dilution liquid to the second washed fermented dairy material to form a third diluted dairy slurry;
g) separating the third diluted dairy slurry into a third washed fermented dairy material and a third filtrate; and, optionally
h) adding a volume of a fourth dilution liquid to the third washed fermented dairy material to form a fourth diluted dairy slurry; and
i) separating the fourth diluted dairy slurry into a fourth washed fermented dairy material and a fourth filtrate,
wherein the third and/or the fourth washed fermented dairy material has at least 20% fewer sugars than the fermented dairy material.

10. A system for making a reduced sugar fruit-flavored dairy product, the system comprising:
a first separation stage including
an inlet for a fermented dairy material having sugars;
an inlet for a volume of a first dilution liquid including a fruit-based material;
one or more filtration membranes;
an outlet for a first washed fermented dairy material; and
an outlet for a first filtrate; and
a second separation stage including
an inlet for the first washed fermented dairy material;
an inlet for a volume of a second dilution liquid;
one or more filtration membranes;
an outlet for a second washed fermented dairy material; and
an outlet for a second filtrate.

11. The system of claim 10, wherein the one or more filtration membranes are spiral wound or plate and frame filtration membranes.

12. The system of claim 10, wherein the first separation stage is configured to perform diafiltration.

13. A reduced sugar fruit-flavored dairy product comprising:
a washed fermented dairy material that includes reduced sugar fruit-based material and has an organic acid content of 1.0 wt % or less and a weight ratio of protein to carbohydrate of at least 1.1:1.

14. The dairy product of claim 13, further comprising a prep.

15. The dairy product of claim 14, wherein 65-90% of the dairy product is the washed fermented dairy material and 10-35% of the dairy product is the prep.

16. The dairy product of claim 13, wherein the dairy product is an animal-derived yogurt or a non-animal-derived yogurt.

17. The dairy product of claim 13, wherein the dairy product is an animal-derived cream cheese or a non-animal-derived cream cheese.
